(19) United States
(12) Patent Application Publication
(10) Pub. No.: US 2025/0124379 A1
(43) Pub. Date: Apr. 17, 2025

(54) CENTRALIZED CLOUD SERVICE MANAGEMENT

(71) Applicant: ConnectWise, LLC, Tampa, FL (US)

(72) Inventors: Christopher Rayner, Seattle, WA (US); Evan Richman, Seattle, WA (US); Bradley Younge, Denver, CO (US); Robert P. Karaban, Rochester Hills, MI (US); John Dennis, Oakland, CA (US); Todd Schwartz, Seattle, WA (US); Darren D. Peterson, Redmond, WA (US); Peter Joseph Wilkins, Troy, MI (US); Matthew Steven Hintzke, Woodinville, WA (US); Sergii Semenov, Kirkland, WA (US); Alex Zammitt, Riverview, MI (US); Philip Pittle, Seattle, WA (US)

(21) Appl. No.: 18/933,600

(22) Filed: Oct. 31, 2024

Related U.S. Application Data
(63) Continuation of application No. 17/152,778, filed on Jan. 19, 2021.
(60) Provisional application No. 62/963,024, filed on Jan. 18, 2020.

(51) Int. Cl. G06Q 10/0631; G06F 16/22; G06F 16/28; G06F 16/901; G06Q 50/10; H04L 9/40; H04L 67/14

(52) U.S. Cl. CPC G06Q 10/06315; G06F 16/22; G06F 16/288; G06F 16/9024; G06Q 50/10; H04L 63/102; H04L 63/105; H04L 63/20; H04L 67/14

(57) ABSTRACT

An information retrieval method for cloud service administration is provided. The method may include establishing a connection with a semantic database. In some embodiments, the semantic database is configured to store information for different cloud services, and the information includes information regarding a first cloud service and information regarding a second cloud service. In some embodiments, the information regarding the first cloud service includes a first entity information and the information regarding the second cloud service includes a second entity information. The method further includes transmitting to the semantic database a request to obtain information regarding an asset. Then the method may include receiving from the semantic database an indication that first entity information and the second entity information being linked and being both related to the asset.

### CROSS-REFERENCES TO RELATED APPLICATIONS

This application claims the priority to U.S. Provisional Patent Application No. 62/963,024, filed on Jan. 18, 2020, entitled with “CENTRALIZED CLOUD SERVICE MANAGEMENT,” the disclosure of which is hereby incorporated by reference in its entirety for all purposes.

### BACKGROUND OF THE INVENTION

Modern companies and associated IT services need to manage the software services that the companies provide to employees. This process can involve provisioning and ongoing management of a variety of computer services from a variety of vendors to employees of a company. Today the service is used by external IT service providers but we will likely offer the service directly to the companies themselves to their internal IT staff. IT consulting firms can be hired by companies to manage the IT environment. The services can often have various differing user interfaces and data formats, which can require a high level of overhead to manage.

Onboarding process is commonly referred to a process for adding a new employee to a company's system(s) and to facilitate the new employee to be able to perform his/her job at the company. Before the new employee starts at the company, this process typically involves administrative steps typically beginning with the IT service of the company receiving a ticket to add this new employee to the company's system(s). This typically involves adding the new employee to the payroll system, assigning a network ID to the new employee, and assigning an email address to the new employee. After these initial administrative steps, the onboarding process may involve determining which system(s) and/or network(s) the new employee should be able to access and not be able to access; and privilege and power the new employee should have on the system(s) and network(s) the new employee will have access to. These determinations will help create appropriate access level(s) and security level(s) for the new employees within the company's system(s). Then, the onboarding process may involve determinations which applications, software, and/or type of computing/communication device the new employee should use.

Different employees may need various access rights to different software services, and those access rights can vary based on for example an employee's role. For example, certain employees should be provided with different access to software services. However, the recognition of and management of groups of users as opposed to individual users can be challenging. The new employee's role typically includes one or more departments/groups the new employee will be in, one or more job tasks/functions the new employee will perform, one or more positions of this new employee in the company and/or within the departments/groups this new employee will be assigned to. For example, a new employee at accounting department holding a manager position will have a very different set up in the onboarding process than a new employee at sales department as a sales representative for the company.

Employee Onboarding system typically enables the IT service of the company to automate some of the repetitive and tedious manual creation of the new employee in the company's system(s) and automatically provisioning tasks to onboard new employees. Some conventional employee onboarding systems provide graphical tools for drawing workflows, but typically lack a well-defined structure. It could be a challenge to get a very specific protracted outcome using those tools. Also, some of the conventional employee onboarding systems are too general and do not provide enough functionality to improve/automate the onboarding process.

Embodiments of the invention address these and other problems, individually and collectively.

### BRIEF SUMMARY OF THE INVENTION

In one aspect of the present disclosure, an information retrieval method for IT service administration is provided. In some embodiments, a centralized IT service management system is provided. The centralized IT service management system in those embodiments may be configured to facilitate one or more IT service providers to provide IT service to customers of the IT service providers. In those embodiments, the centralized cloud service management system may be configured to execute the aforementioned information retrieval method. In some embodiments, the aforementioned method may include establishing a connection with a semantic database. In some embodiments, the semantic database is configured to store information for different cloud services, and the information includes information regarding a first cloud service and information regarding a second cloud service. In some embodiments, the information regarding the first cloud service includes a first entity information and the information regarding the second cloud service includes a second entity information. The method further includes transmitting to the semantic database a request to obtain information regarding an asset. Then the method may include receiving from the semantic database an indication that first entity information and the second entity information being linked and being both related to the asset.

Other embodiments are directed to systems and computer readable media associated with methods described herein.

Numerous benefits are achieved by way of the present disclosure over conventional techniques. For example, embodiments of the present disclosure provide a method of retrieving information for cloud service administration, which can link user accounts of different cloud services that represent the same user. When deploying these cloud services to one user, the method provided by the present disclosure can save the repeat input of the identical user information for configuring the user under different cloud services. These and other embodiments of the disclosure along with many of its advantages and features are described in more detail in conjunction with the text below and attached figures.

A better understanding of the nature and advantages of embodiments of the present disclosure may be gained with reference to the following detailed description and the accompanying drawings.

### BRIEF DESCRIPTION OF THE DRAWINGS

FIG. 1 is a system diagram showing an example environment where an example management system in accordance with the disclosure is applied in.

FIG. 2 illustrates an example of client-service relations in accordance with the present disclosure.

FIG. 3 illustrates a part of the graph database according to some implementations of the present disclosure.

FIG. 4 shows an example of the user information data in accordance with the present disclosure.

FIG. 5A shows an example of annotating properties of a user account from Microsoft Office 365 using generic vocabularies.

FIG. 5B shows an example of annotating properties of a user account from Dropbox with the generic vocabularies.

FIG. 5C illustrates properties in data models across multiple services can be annotated using generic vocabularies.

FIG. 5D illustrates one example of an applications that can employ annotated generic vocabularies in accordance with the disclosure.

FIG. 5E illustrates one example of an applications that can employ annotated generic vocabularies in accordance with the disclosure

FIG. 6 illustrates a part of the graph database according to some implementations of the present disclosure, showing the transitive cluster including assets linked by an equivalent edge.

FIG. 7 shows the different situations of the transitive cluster in accordance with the present disclosure.

FIG. 8 shows an example interface for displaying customers of a given the IT service end user in accordance with the present disclosure.

FIG. 9 shows an example interface to display a view of different entities for a customer of the IT service end user in accordance with the present disclosure.

FIG. 10 shows an example interface to display a composite view showing detailed information of an asset in accordance with the present disclosure.

FIG. 11 shows another example interface for displaying a composite view of entities for a given customer in accordance with the present disclosure.

FIG. 12 shows an example interface for displaying common information for an entity across services in accordance with the present disclosure.

FIG. 13 illustrates an exemplary method for managing different assets of a graph database in accordance with the disclosure.

FIG. 14 illustrates an example method for linking assets in accordance with the present disclosure.

FIG. 15 illustrate an example method for unlinking assets in accordance with the present disclosure.

FIG. 16 shows an example computer apparatus for implementing various embodiments in accordance with the disclosure.

### DETAILED DESCRIPTION OF THE INVENTION

Information Technology Service Management (ITSM) are the activities that are performed by an organization to design, plan, deliver, operate and control information technology (IT) services offered to clients of the organization. An information technology service management system (“management system” hereafter) in accordance with the present disclosure can facilitate an IT service provider to provide central administration of cloud services licensed by multiple, disparate entities. In the case of cloud services managed by an ITSM, these entities would typically be licensed by their customers. In some embodiments, the management system in accordance with the present disclosure can provide a set of tools to enable the IT service provider to provide the IT service to the customer. The IT service provided by the IT service provider to the customer may include system/user administration, cloud service administration, cloud platform or infrastructure management, and/or any other services provided by the IT service provider to the customer. The management system in accordance with the disclosure can facilitate integrated access to one or more services employed by the customer of the IT service provider by collecting data related to for example, passwords, licenses, schedules, health, analytics, and general data that is stored within or provided by the services. The management system in accordance with the disclosure can collect this data in a cross service fashion and provide it in one or more simplified user interfaces to allow for easier management of the services through the management system.

### I. Example System Architecture

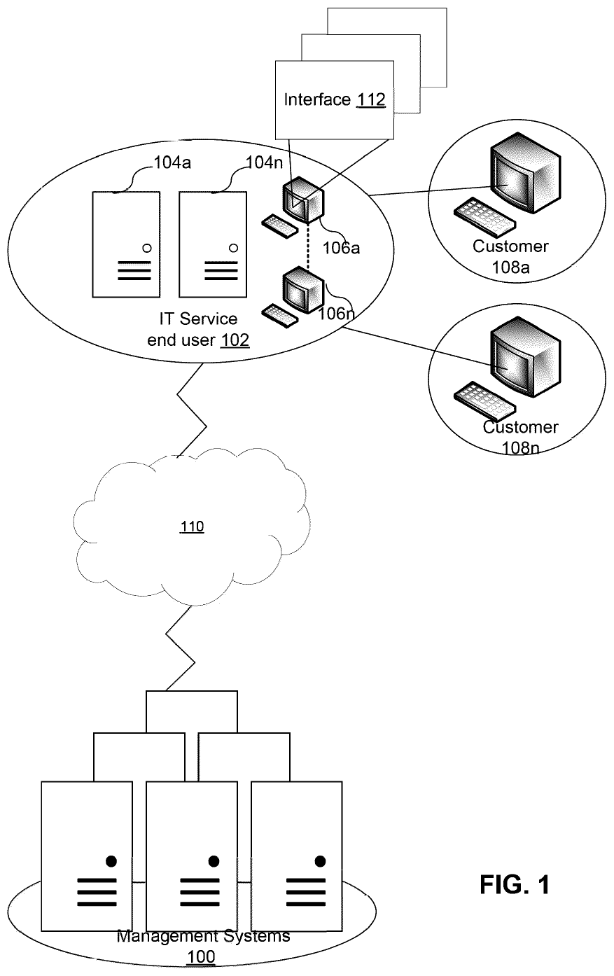

FIG. 1 is a system diagram showing an example environment where an example management system in accordance with the disclosure is applied in. As shown, the example environment can include an example management system 100. The example management system 100 can be configured to provide one or more software services to an IT servicer end user 102 to enable the IT service end user 102 to provision one or more IT and/or computing services to one or more customers of the IT end user 102, such as customers 108a to 108n as shown in this example. Although only one the IT service end user 102 is shown in FIG. 1, it should be understood that the management system 100 may be configured to provide the aforementioned software services to more than one the IT service end user 102. The IT service end user 102 can be an internal IT organization or an external IT services company or even individual person. The recipients of services provided by IT service end user, e.g., the customers 108a to 108n shown in this example, can be a line of business (LOB) organization within an enterprise, an entire company, a department within an entity, a store, a facility, and/or any other entities. For example, the IT service end user 102 can be a specialized IT service company that provides help-desk type service to multiple companies. As another example, IT service end user 102 can be an IT department within a company/or enterprise. By providing the aforementioned software services, the management system 100 can assist the IT service end user 102 to place greater emphasis on the needs and the outcomes required by the business. In some implementations, the software services may be provided by the management system 100 through one or more interfaces that can be accessed by the terminal(s) of the IT service end user 102, such as the interfaces 112 shown in FIG. 1.

As shown, the IT service end user 102 may employ one or more systems such as system 104a to 104n as shown in this example to facilitate the IT service provided to its customers 108a-n. Such system(s) can enable the IT service end user 102 to provision the one or more IT and/or computing services to the customers 108a-n of the IT service end user 102. The IT service end user 102 may include one or more terminals, such as terminal 106a to 106n shown in this example. Such terminal(s) can enable a user in the IT service end user 102 to interface with the management system 100 for provisioning the IT and/or computing services to the customers 108a-n.

As shown, one or more of the systems 104a-n and/or terminals 106a-n of the IT service end user 102 may be connected with the management system 100 through a network/cloud 110. The connections between the example management system 100 may be various, which may include internet, intranet (wireless or wired), and/or any other suitable connections. As mentioned above, the IT service end user 102 may be internal or external to a given customer, such as customer 108a or client 108n. When the IT service end user 102 is internal to the client, the connection(s) may be through one or more intranets of the customer; and when it is external to the customer, the connection(s) may be through the Internet.

Traditionally, IT service provided to a given customer, e.g., customer 108a, by the IT service end user 102 typically involves collecting relevant data from the customer 108a and/or service providers of customer 108a, and provide system/service/user administration based on the data collected. Using user administration as an example, customer 108a may have a set of users internal to the customer 108a (e.g., sales department of customer 108a), and customer 108a may employ multiple cloud/software services for these users. Traditionally, user management in this scenario would involve user management for customer 108a, and user management for each individual cloud/software service. For instance, if a user is to be added to the sales department of customer 108a, not only is an user management action of adding the user to the sales department group of customer 108a (e.g., a user group called “sales” created for customer 108a) needed, but also is it needed for the individual cloud/software service. The user management action may involve supplying new user information such as the user's first and last name, phone number, organization email address, age, one or more departments/groups the user belongs to, and/or any other information. Each individual software/cloud service may also need its idiosyncratic information for fulfilling the software/cloud service to this new user. This process can thus be laborious and tedious especially when a large amount of users need be add/deleted/edited within customer 108a. The complexity of IT service tasks for customer 108a can drastically increase when multiples steps and services are involved.

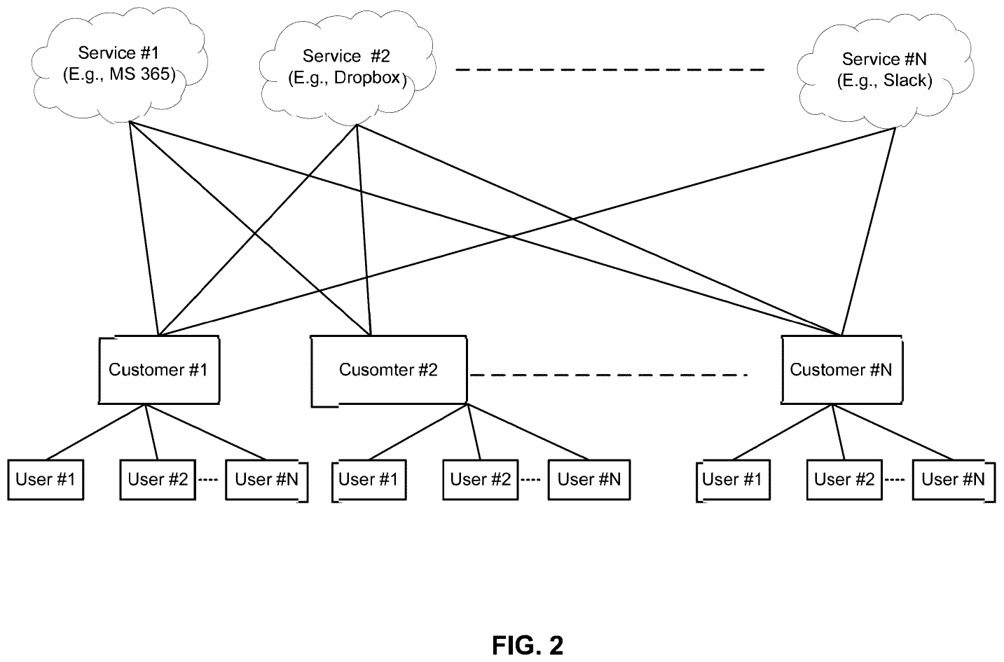

FIG. 2 illustrates an example of customer-service relations for an IT service end user 102 in accordance with the present disclosure. Typically, a customer of the IT service end user 102, such as customer 108a, may subscribe to many cloud services. For example, customer #1 may subscribe to service #1 (e.g., Microsoft Office 365), service #2 (e.g., Dropbox), and/or service #N (e.g., Slack). In some implementations, customer #1 may have different users subscribing to different services depending on, for example, corporate management policies and service subscription agreements. For example, customer #1 may hire a new employee user #1 for its sales department. User #1 is supposed to subscribe to service #1 and service #2 to perform for his business role. In the onboarding procedure, the IT department of customer #1 equipped with a conventional management system must configure service #1 and service #2 for user #1 separately. Personal information of user #1 required for configuration of service #1 must be repeated for configuration of service #2.If user #1 transfers to another department where service #3 is required, the IT department of customer #1 equipped with the conventional management system must repeat the configuration process again to input the personal information of user #1.With the growth of customer #1,user number may increase dramatically. The repeated configuration process may consume considerable resources of customer #1.In some implementations, a management system based on a graph database is proposed to reduce the repeated configuration process.

One insight provided by this present disclosure is that entities within a software/cloud services (“service” or “services” for ease of description hereinafter) may be linked to entities within another service (entity linking hereinafter). As used herein, an entity within a service may be referred to as an asset provided by the service, for example, a user account, a user group, a license, an email inbox, a storage, and/or any other types of assets provided by the service. Typically, entities or assets may have relationships amongst themselves within and/or across the individual services. For example, a user account in service #1 and another user account in service #1 may belong to the same user within customer 108a, and thus they can be linked.

Therefore, a revelation by the inventors of this disclosure is that entity information for services employed by a given customer may be captured and modeled semantically such that relationships among the entities of the services may be established. Based on these relationships, a number of applications can be built. For example, a set of common operations may be developed. An individual one of these commands can be executed to automatically trigger actions to multiple services. Another application may be creating a model asset for a set of related entities across the services—for example a common user model. The common user model may include one or more properties common to multiple entities across different services. This common user information may be used to model a generic user for these different services. When certain user information needs to be propagated throughout the services, this can be achieved through this common user model.

Another insight provided by the inventors of this disclosure is that graphical user interfaces can be employed to display multiple services associated with an entity, such as a user, a user group, a department, a branch, a subsidiary and the like, within customer 108a-entity composite view hereinafter. These graphical user interfaces can be used to instigate the above-mentioned changes to the entities. For example, if a user group within customer 108a has changed its name, this update can be propagated to the multiple services where this user group exists through the graphical user interface. This can allow an administrator of the IT service end user 102 to simplify administration tasks for customer 108a in an intuitive manner.

II. Asset Management

In accordance with the present disclosure, assets in different services for a given customer may be retrieved from these services. As used herein, an asset may be referred to as an entity or a document within a given service. In various sections, assets of a service are used interchangeably with entities of the service. For example, a user account within the given service may be an asset because it is an entity within the given service. In implementation, information about this user account may be provided by the service in a document—for example a document listing information regarding a user of this user account. Other examples of an asset may include user groups, licenses, user mailboxes, virtual storage spaces, service information, and/or any other types of assets. One insight provided by the present application is that assets across different services may be stored by the management system 100 semantically. Traditionally, such assets are typically modeled through schemas and are stored in a relational database according to the schemas.

One challenge with the schema approach is that assets across different services are complicated in terms of their structures. They do not always necessarily map to each other perfectly. For example, user account in one service may comprise a first set of user information and user account in another service may comprise a second set of user information. The first set of user information may only partially overlap with the second set of user account. Thus, these two assets may not fit nicely under a schema. The inventors of the present disclosure realize assets across different services may be managed within the management system 100 by modeling them semantically instead of modeling them schematically. Through the semantic modeling, relationships for assets across different services may be established.

### Sematic Modeling of Assets of Services

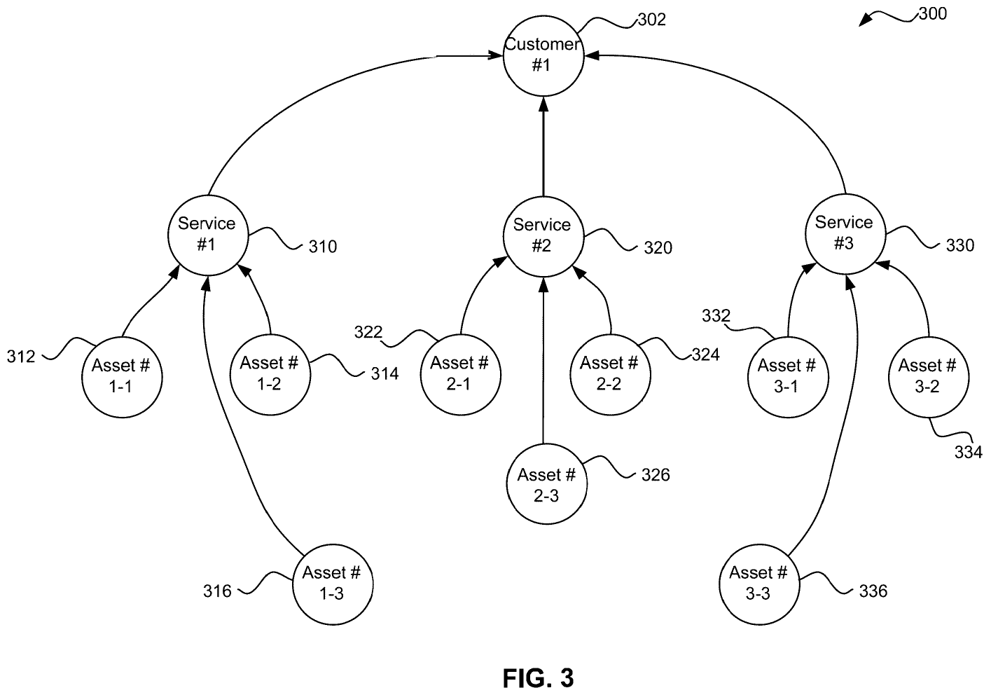

At its most basic, semantic modeling is used to depict the relationships that exist among specific values of data, such as the example shown in FIG. 3. In implementations of embodiments in accordance with the present disclosure, semantic modeling is applied to entities/assets of services employed by a given customer. In some implementations, a graph database is used to facilitate the sematic modeling in accordance with the disclosure. However, it should be understood the present disclosure is not only limited to graph database. Graph database described herein is merely for illustration of how cross-service assets may be stored and modeled semantically. Other examples of semantic database are contemplated.

### 1. Entity Information Capture Using a Graph Database

In computing, a graph database (GDB) is a database that uses graph structures for semantic queries with nodes, edges, and properties to represent and store data. A key concept of the system is the graph (or edge or relationship). The graph relates the data items in the store to a collection of nodes and edges, the edges representing the relationships between the nodes. The relationships allow data in the store to be linked together directly and, in many cases, retrieved with one operation. Graph databases hold relationships between data as a priority. Querying relationships within a graph database is fast because they are perpetually stored within the database itself. Relationships can be intuitively visualized using graph databases, making them useful for heavily inter-connected data. Graph data modeling is a process in which a user describes an arbitrary domain as a connected graph of nodes and relationships with properties and labels.

Currently, there are a number of graph databases, such as Azure Cosmos DB and Neo4J. These graph databases provide basic management of graph data in persistent data storage. These graph databases provide a low-level application programming interface (API) that a user can use to access graph data from persistent storage. Therefore, if a user wants to run a graph algorithm on top of the graph data, then the user may come up with an implementation on top of the low-level API. One insight provided by the inventors of this disclosure is that semantic database such as a graph database can be used to store service information for a given customer of the IT service end user 102. The service information can be used to establish one or more relationships among entities within different services employed by the customer. These established relationships can then be used to facility entity linking or entity composite view features mentioned above.

FIG. 3 illustrates a part of a graph database 300 according to some implementations of the present disclosure. For example, graph database 300 may be an Azure Cosmos DB. In some embodiments, management system 100 may access the graph database through one or more data access APIs. In some embodiments, graph database 300 may be implemented on one or more computing devices, such as systems 104a-104n and/or management system 100. If graph database 300 is implemented on multiple computing devices, the multiple computing devices may be coupled to each other. As noted previously, graph database 300 stores datasets about one or more graphs, each comprising multiple nodes and edges (also called “relationships”). In some embodiments, graph database 300 may be a relational database or an object database. For example, one node table in graph database 300 may include a row for each node in a graph. (Graph database 300 may store a different node table for each graph represented in the graph data.) Each column in the node table may correspond to a different attribute or property of the node, such as a name, an age, and a date, depending on the type of object the nodes represent.

Nodes in a graph may represent one of many different types of objects while edges that connect two nodes in the graph may represent one of many different types of relationships between the objects. Embodiments are not limited to any particular type of object or type of relationship. For example, nodes in a graph may represent user accounts maintained by a social network that is provided by a social network provider, such as Facebook, Google+, LinkedIn, and Twitter. An edge in such a graph may represent that the two connecting nodes have established a relationship with each other or that one of the connecting nodes has decided to “follow” the other node (as in Twitter).

As shown in FIG. 3, graph database 300 may include a plurality of nodes. For example, graph database 300 may include three types of nodes: customer nodes, service nodes, and asset nodes. These nodes are linked by relationships (shown as curves with an arrow) among themselves. For example, as shown here, graph database 300 includes customer node 302, and service nodes 310, 320, and 330. In graph database 300, for example, customer node 302 represent customer #1 shown in FIG. 2, service node 310 represents service #1, service node 320 represents service #2, and service node 330 represents service #3. Each of service nodes 310, 320, and 330 is linked to customer node 302 by a directed relationship as shown by the curve with an arrow. In some embodiments, the directed relationship between a service node and the client node represents a relationship there between. For example, the directed relationship between service node 310 and customer node 302 may represent the relationship of “SERVE,” which means service #1 serves customer #1. It should be noted that the part of graph database 300 is presented as an example. In some embodiments, graph database 300 may include a plurality of customer nodes 302 that represent customer #1 to customer #N as shown in FIG. 2. In some embodiments, a client node may be linked to a plurality of service nodes that represent service #1 to service #N as shown in FIG. 2.

As shown in FIG. 3, service node 310 may be linked to asset nodes 312, 314, and 316, which represent asset #1-1, asset #1-2, and asset #1-3, respectively. Service node 320 may be linked to asset nodes 322, 324, and 326, which represent asset #2-1, asset #2-2, and asset #2-3, respectively. Service node 330 may be linked to asset nodes 332, 334, and 336, which represent asset #3-1, asset #3-2, and asset #3-3, respectively. It should be noted that each service node may be linked to more or less asset nodes.

In some embodiments, an asset as shown in FIG. 3 represents the way in which a service is provisioned to a customer. For example, an asset may represent a user account subscribed to a service. In some embodiments, an asset may represent a group in the client company, such as sales department, marketing department, R&D department, or human resource department. In some embodiments, an asset may represent a license that is granted to use the service. In some embodiments, an asset may represent an organization within the client. It should be noted an asset node is not limited as mentioned above. In some embodiments, each node in graph database 300 may bear a label of node type. For example, an asset node in graph database 300 may be labeled with an asset type. For example, asset node 316 may be labeled as “user,” which means the asset #1-3 represents a user account of service #1. For example, asset node 324 may be labeled as “group,” which means asset #2-2 represents a group entity of service #2. For example, asset node 332 may be labeled as “license,” which means the asset #3-1 represents a license entity of service #3. It should be noted that the above asset types are presented for illustration purposes without limitation.

A node in a graph database may include one or more properties. For example, the properties of a user node may include properties like first name, last name, email, telephone number, address, etc. In constructing the graph database 300, a set of data may be downloaded from different services and stored in graph database 300 as nodes. For example, a set of data (e.g., JSON payload) may be downloaded through data access APIs and stored in graph database 300 as data nodes.

### 2. Model Information for a Given Type of Entity Information

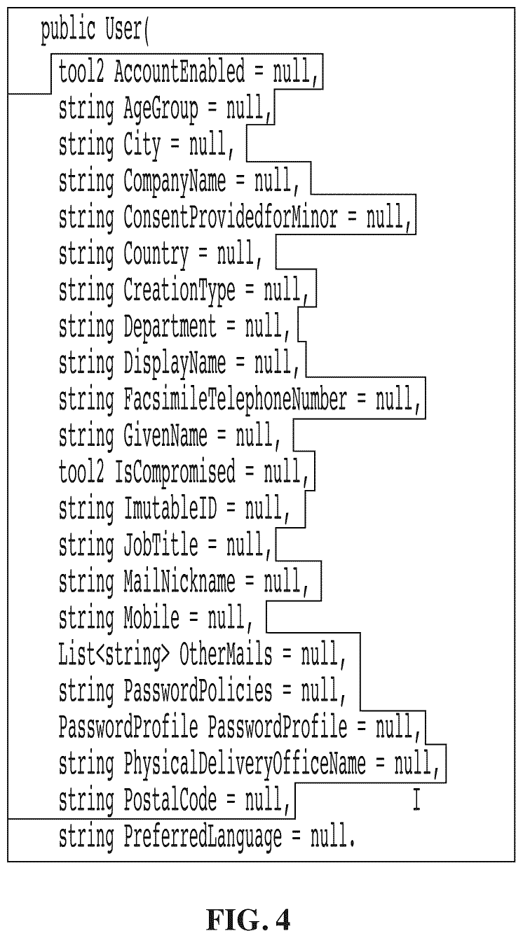

For any given service, such as MS 365, Gmail, Dropbox, Slack and any other service, entity of asset information can be retrieved for a given customer from the given service through APIs provided by the given service. Typically, the given service provides model information for a given type of entity to enable parsing of the entity information of the given type. For example, MS 365 may provide a list of model information for assets it provides within MS 365. FIG. 4 illustrates such model information for an asset of a given type in a service.

FIG. 4 shows an example of model user information for a particular service employed by a given customer, for example customer 108a shown in FIG. 1, of the IT service end user 102. For example, service #1 in graph database 300 as shown in FIG. 3 may represent Microsoft Office 365. Management system 100 may be configured to retrieve model user information from Microsoft Office 365 and store the model user information. That is, in this example, the model user information (or metadata) is regarding users for MS 365. This model user information can be used to populate individual nodes in the graph data base shown in FIG. 3, such as asset #1-3. As another example, service #2 in graph database 300 shown in FIG. 3 may represent Dropbox. Management system 100 may be configured to retrieve user account information from Dropbox using model user information for Dropbox and store such information in asset #2-3. Table 1 below illustrates one example of model user information for a given service, such as service #1 shown in FIG. 1. It should be understood the model user information shown in FIG. 1 is merely for illustration and thus should not be understood as limiting. It is understood that different services may have different model user information for their users.

TABLE 1
Property label

ObjectId
GivenName
Surname
Displayname
UserPrincipleName
Mobile
TelphoneNumber
AcccountEnabled
ObjectType
Deletion Timestamp
AgeGroup
AssignedLicenses
AssignedPlays
City
Compnay Name
. . .

For the purpose of illustration, the present disclosure below will be described with reference to part of the properties, such as GivenName, Surname, UserPrincipleName, and TelephoneNumber. Thus, asset #1-3 may include a set of properties to describes a user account. One example of a user account instance from Microsoft Office 365 may be presented in asset #1-3 like follows:

| Property Label | Value |
|---|---|
| given name | Joni |
| surname | Sherman |
| user principle name | JoniS@M365B619246.OnMicrosoft.com |
| telephone number | +1 980 555 0101 |

### 3. Entity Information Semantic Modeling

As described above, entity information of a given type may be retrieved from a given service and stored in a node in a graph database. Eventually, nodes in the graph database, such as graph database 300 shown in FIG. 3, are populated with entity information of different services employed by a given customer. As also described above, one objective of this exercise (storing entity information for different services in the graph database) is that relationships among different entities across different services may be established. For achieving this, model information for different types of entity information may be examined. As shown above, for example, model information for a user type in different services may have a set of common information and their own idiosyncratic information. For instance, the common information may include given name, surname, email, and phone number, etc. of a user. The service specific information can vary from service to service.

### Annotating Assets

One insight provided by the present disclosure is that generic vocabularies may be developed to annotate entities or assets across different services. The generic vocabularies may represent a knowledge of how IT services are provided by the IT service end user 102 to its customer information. In essence, properties within a given data model can be annotated using the generic vocabularies. For example, the model user information for MS 365, Slack, Dropbox, Gmail and etc. may be annotated with a set of generic vocabularies. In one implementation, this annotation can be achieved automatically through parsing of the model information for a given entity type. In another implementation, this annotation can be achieved by manually marking the common information in model information for a given type of entity of a given service. For example, information in the model user information for MS 365, Gmail, Dropbox, Slack, may be automatically or manually parsed and annotated with generic vocabulary.

In the case of user information, the generic vocabularies may include GivenName, FamilyName, EmailAddress, and CellPhone, etc. Such generic vocabularies may be developed for annotating properties in a given user data model of a given service. For instance, the GivenName in the generic vocabularies can be used to annotate the property “GivenName” of asset #1-3, and can also annotate the property “given name” of asset #2-3. As another example, the email address in the generic vocabularies can mark up the property “UserPrincipleName” of asset #1-3, and can also annotate the property “email” of asset #2-3.

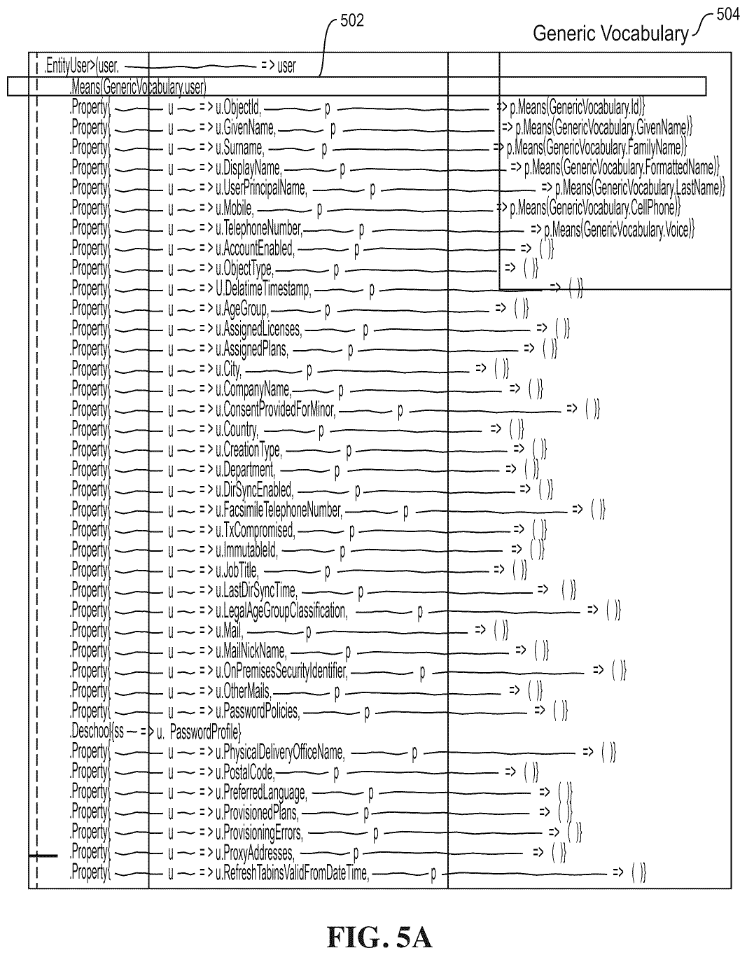

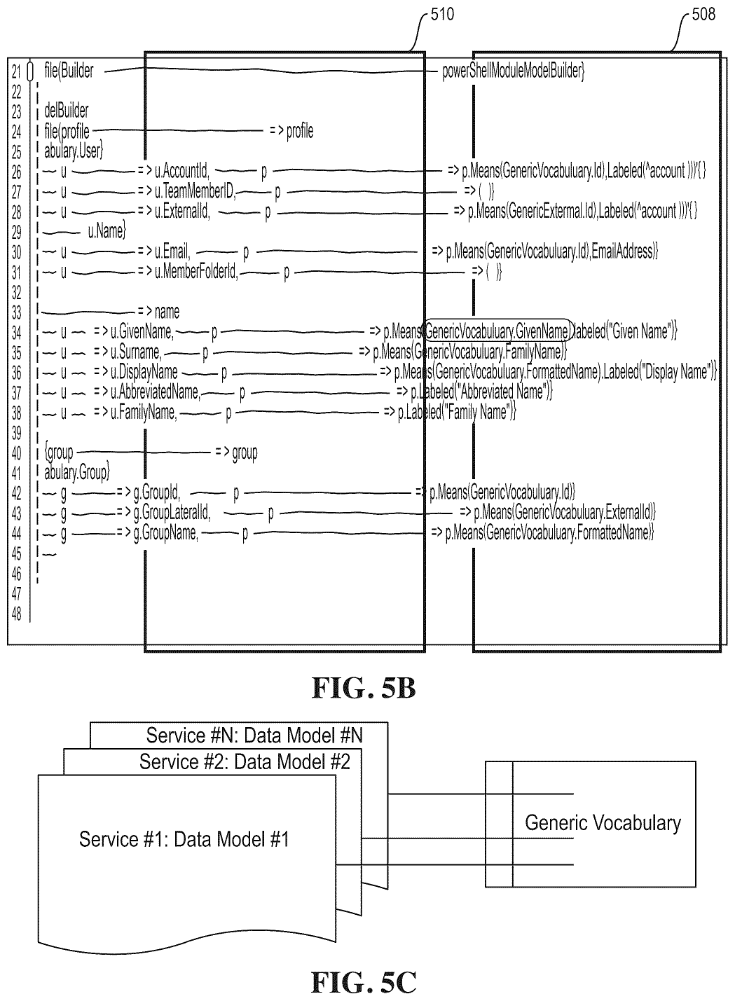

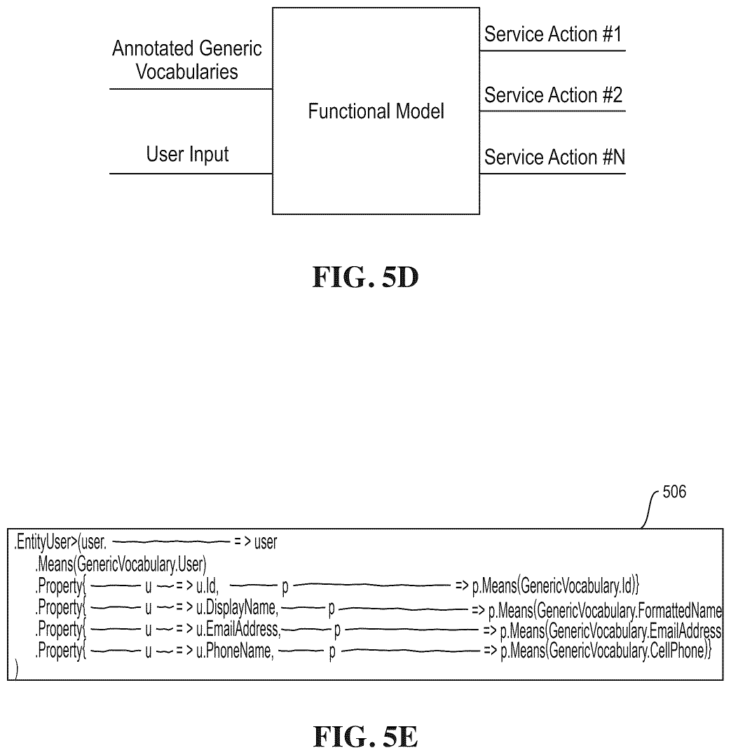

FIG. 5A shows an example of annotating properties of a user account from Microsoft Office 365 using generic vocabularies 504. As shown in FIG. 5A, block 502 shows part of the properties from user account information of Microsoft Office 365, and block 504 shows generic vocabularies can be used to annotate the properties within the user account information of Microsoft Office 365. As can be seen from FIG. 5A, in some embodiments, a part of the properties of the user account is marked up by the generic vocabularies. In some embodiments, all of the properties of the user account may be marked up by the generic vocabularies.

FIG. 5B shows an example of annotating properties of a user account from Dropbox with the generic vocabularies. As shown in FIG. 5B, block 510 shows properties from a user account information of Dropbox, and block 508 shows generic vocabularies can be used to annotate the user account information of Dropbox. By using such a set of generic vocabularies as shown in FIGS. 5A-5B, a translation connector may be established between different services.

FIG. 5C illustrates properties in data models across multiple services can be annotated using generic vocabularies. As shown, during a management phase for the IT service end user 102, data model information stored in the graph database can be annotated using the generic vocabularies. This is akin to deconstructing structures in data models provided by different services by mapping them to the generic vocabularies. As mentioned, the generic vocabularies may be developed based on a knowledge of how IT services are provided or administered by the IT service end user 102.

Based on the annotated generic vocabularies, a number of applications can be developed. FIG. 5D illustrates one example of an applications that can employ annotated generic vocabularies in accordance with the disclosure. As shown, in some embodiments, a functional model can be developed to automatically generate service actions to different services based on a user input. For example, an action may be changing a last name for a user. The functional model can take the user input of information regarding the user for whom the last name is to be changed. The functional model may consult annotated generic vocabularies and identify which services may need actions to change user account information for that user. This can be achieved because the annotations illustrated above serve as connectors to show which services have information mapping to the generic vocabularies-such as last name of a user. Based on identified services, a number of actions can be determined to instigate the last name changing operations for these services. This may involve parameterizing or substantiating those operations using the user input received by the functional model. As a result, service actions as shown in FIG. 5D can be created automatically to instigate the last name changing operations for these services.

### Common User Information

Another example of application may be developed based on the annotated generic vocabularies is creating common data models across different services. For example, a common model information of a given entity type may be created within management system 100 to capture information common to entity information of the given entity type across different services. For instance, after annotating the assets across the different services, it may be discovered certain assets in those service all map to a set of generic vocabularies. Based on this mapping, the common data model may be created to capture this set of generic vocabularies as properties in the common data model. FIG. 5E illustrates an example of a common user model 506 developed based on generic vocabularies mapped to properties of data models related to user account information across the different services—for example the ones shown in FIG. 5A and FIG. 5B. The common user model 506 may be used to develop a tool that can assist a user within the IT service end user 102 to better search or managing user information across different services.

### 4. Entity Linking

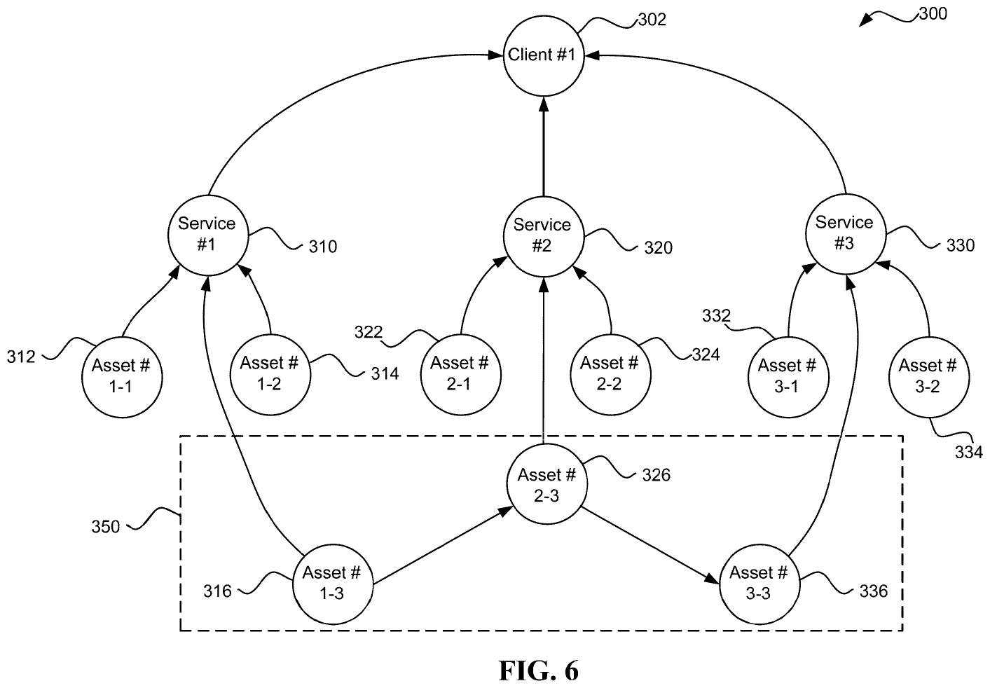

With entity information semantic modeling having been described, attention is now directed to entity linking based on the semantic modeling. As mentioned above, entity linking is a concept of linking related entities within different services. For example, an entity-user Joni Sherman within the given customer may use Microsoft Office 365 and Dropbox. In graph database 300 shown in FIG. 3, asset #1-3 may represent user account information of Joni Sherman in Microsoft Office 365 (as service #1), and asset #2-3 may represent user account information of the same Joni Sherman in Dropbox (as service #2). In such a case, as shown in FIG. 6, management system 100 may access the graph database 300 and create an equivalent edge to link asset #1-3 and asset #2-3. In implementation, one or more linking rules may be developed to include preset criteria for mining entity information stored in the graph database 300 and linking related entities automatically. For example, in the case of user account linking, a linking rule may be developed such that if a user account of particular service comprise a first name and last name match another user account of another service, these two user accounts may be linked together. Different linking rules may be developed for different entity types. For example, user groups across different services may be linked together if the same users exist in those user groups or the user groups share a same group name (e.g., sales team). Other linking rules for other entity types are contemplated.

### (1) Transitive Cluster

In some embodiments, graph database 300 may include a transitive cluster comprising equivalent nodes. As used herein, transitive cluster may be referred to linking two entities indirectly because they are both related to one or more entities that are already linked. In one implementation, each node within the transitive cluster is linked by an equivalent edge with another node. In another implementation, only part of the nodes within the transitive cluster is linked together. As shown in FIG. 6, transitive cluster 350 may include asset #1-3 linked to service #1, asset #2-3 linked to service #2, and asset #3-3 lined to service #3. As shown in FIG. 6, asset #1-3 is linked to asset #2-3, which is linked to asset #3-3. Due to being placed in the transitive cluster, asset #1-3 is also equivalent to asset #3-3 although there is no direct equivalent relationship there between. Considering the properties from different assets may include different labels and/or different values, a comparison algorithm may be adopted to determine if two assets should be linked by an equivalent edge, which will be described in detail below. In some embodiments, the properties of two assets marked by the same generic vocabulary may be compared to determine if the two assets should be linked by an equivalent edge. For example, the value of the property “UserPrincipleName” of asset #1-3 marked by “EmailAddress” in generic vocabularies can be compared with the value of the property “email” of asset #2-3 marked by “EmailAddress” in generic vocabularies to determine if asset #1-3 and asset #2-3 share the same email address, which is an indication that asset #1-3 and asset #2-3 represent the same user subscribed to service #1 (e.g., Microsoft Office 365) and service #2 (e.g., Dropbox). If asset #1-3 and asset #2-3 share the same email address, asset #1-3 and asset #2-3 can be linked by an equivalent edge, and both asset #1-3 and asset #2-3 can be included in the transitive cluster. Using the same comparison strategy, asset #3-3 can be linked to asset #1-3 and/or asset #2-3 if asset #3-3 share the same email address with asset #1-3 or asset #2-3.

It should be noted the above comparison strategy for determining transitive cluster is presented as an example. Any comparison strategy may be contemplated and should be included in the protection scope of the present disclosure if it can be determined that two assets are equivalent to each other. In some embodiments, a composite comparison strategy may be adopted. Different properties of an asset may be considered in this composite comparison strategy. For example, some or all of the properties of two assets marked by “GivenName,” “FamilyName,” “EmailAddress,” and “CellPhone” in generic vocabularies may be compared to determine if two assets should be linked by an equivalent edge. In some embodiments, the linkage of equivalent assets may be performed automatically in constructing graph database 300. In some embodiments, the linkage can be performed manually. For example, all assets may be displayed on interface 112 of management system 100 when an IT service end user 102 queries graph database 300 for a user named Joni Sherman. Then the IT service end user 102 may link some or all of the assets with a name of Joni Sherman. The details of linking equivalent assets are described below.

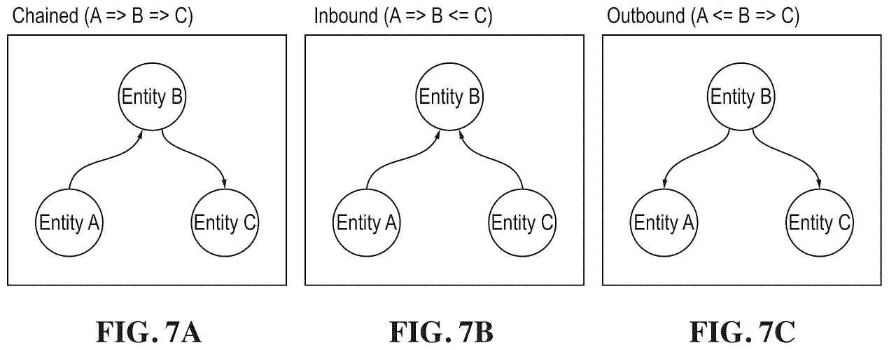

FIG. 7 shows different situations of the transitive cluster in accordance with the present disclosure. In situation (a), entity A is linked to entity B by a directed edge, and entity B is linked to entity C by another directed edge. Then entity A, entity B, and entity C can be defined as belonging to the transitive cluster. In situation (b), entity A is linked to entity B by a directed edge, and entity C is linked to entity B by another directed edge. Then entity A, entity B, and entity C can be defined as belonging to the transitive cluster. In situation (c), entity B is linked to entity A by a directed edge, and linked to entity C by another directed edge. Then entity A, entity B, and entity C can be defined as belonging to the transitive cluster. It should be noted the situations presented in FIG. 7 are examples without limitations. In implementations, various algorithms and/or rules may be developed for detecting the transitive clusters described in FIG. 7. In those implementations, such algorithms and/or rules may be configured into management system 100 to enable the management system 100 to automatically linking entities through transitive clusters detected.

### III. User Interfaces

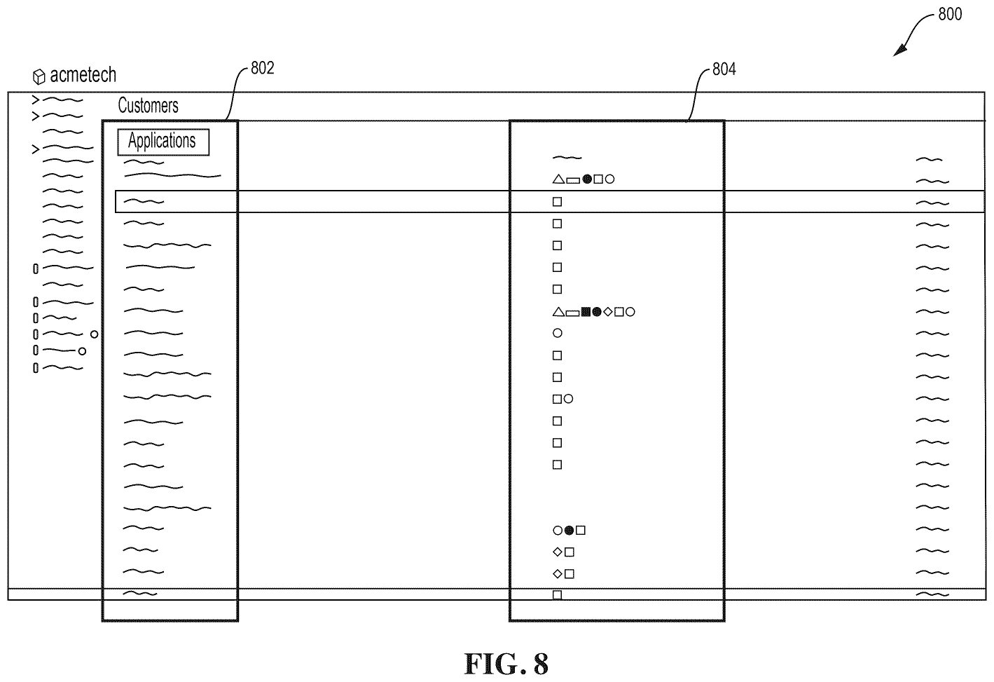

As mentioned above, various user interfaces may be provided to the IT service end user 102 on the terminals 106a-n shown in FIG. 1. These user interfaces may be developed based on the underlying semantic modeling of entity information across different services for customers of the IT service end user 102 described herein. FIGS. 8-12 illustrate some examples of such interfaces in accordance with various embodiments.

### A. Customer View

FIG. 8 shows an example interface 800 displaying customers of a given the IT service end user in accordance with the present disclosure. As mentioned above, the interface 800 may be implemented by management system 100 and presented on a terminal, such as 106a, of the IT service end user 102 shown in FIG. 1. As shown in FIG. 8, each row in block 802 represents a customer of the IT service end user 102, for example, customer #1 as shown in FIG. 3. Each row in block 804 represents services individual customers employ for personnel within their organizations. For example, these services may represent service #1, service #2, and service #3 shown in FIG. 3. Interface 800 can provide a centralized portal for an administrator/staff of the IT service end user 102 to execute IT services provided these customers.

### B. Composite Entity View for a Customer

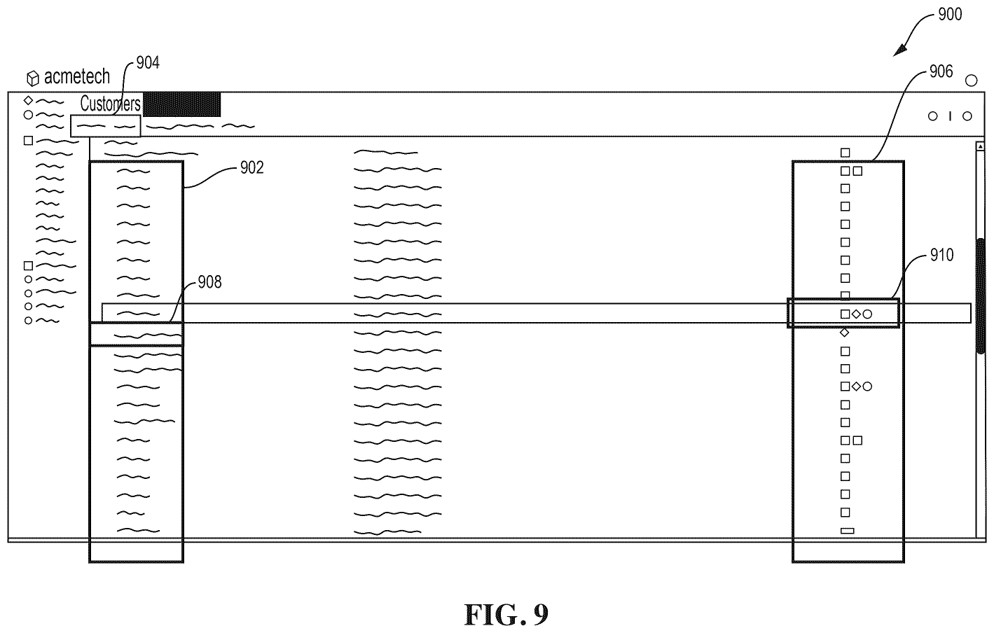

FIG. 9 shows an example interface 900 for displaying a view of different entities for a customer of the IT service end user in accordance with the present disclosure. Interface 900 can be used to assist an administrator or staff of the IT service end user 102 to manage entities for a given customer-acmetech in this example. As shown in FIG. 9, block 904 represents different entities that may be managed in interface 900, such as users or groups within the given customer. Each row in block 902 represents an entity of a selected entity type, for example asset #1-3 linked to service #1 (e.g., Microsoft Office 365) shown in FIG. 3. In this example, the selected entity type is users and thus users within acmetech are shown in interface 900. Each row in block 906 represents one or more services that individual users of acmetech are authorized to use. In some embodiments, if a user is authorized to use different services, block 906 may display those services the user subscribes to. For example, block 908 represents a user named Joni Sherman, who subscribes to Microsoft Office 365, Slack, and Webex.

As mentioned above, interface 900 can be developed because of the entity linking across services employed by acmetech through semantic modeling. In the case of user Joni Sherman, because user accounts of Joni Sherman in Microsoft Office 365, Slack, and Webex are linked together, a composite view of these three services as being associated with Joni Sherman can be displayed in interface 900. It is a composite view in a sense that different services associated with a single entity (Joni Sherman) is displayed next each other. This can make managing user Joni Sherman across these services easier for the administrator or staff of the IT service end user 102. For instance, as shown in interface 900 in this example, the administrator or staff of the IT service end user 102 can just click on block 910 to start managing user accounts for Joni Sherman across these services. For example, the administrator or staff of the IT service end user 102 can change Joni's last name from Sherman to Sherman-Johnson from the central interface, across services. An example of facilitating such a cross-service action is described and illustrated in FIG. 5D.

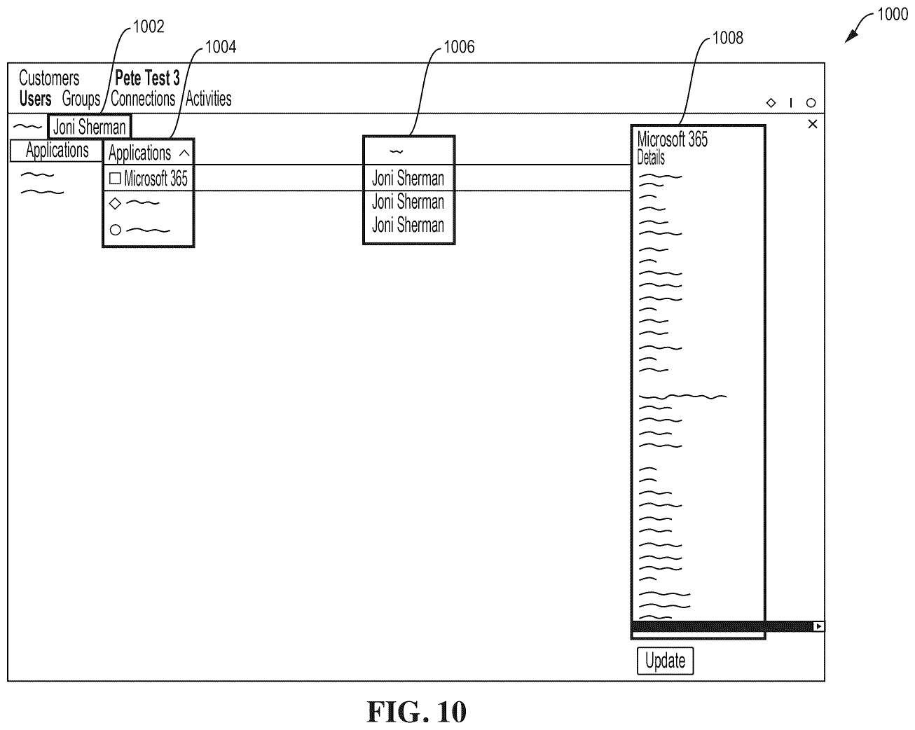

FIG. 10 shows an example interface 1000 to display a composite view showing detailed information of an entity in accordance with the present disclosure. Interface 1000 can be developed to enable an administrator or staff of the IT service end user 102 to zoom in onto an entity shown in interface 900. As shown in FIG. 10, interface 1000 can comprise a block 1002 showing entity identification-such as the user name Joni Sherman showing in this example. Interface 1000 can comprise a block 1004 showing all services associated with Joni Sherman. Interface 1000 can comprise a block 1006 showing the display name of Joni Sherman in different services, and comprise a block 1008 showing the properties of Joni Sherman has in different services. As shown in FIG. 10, block 1008 shows Joni Sherman's properties in Microsoft 365 because Microsoft 365 is selected in the example shown in FIG. 10. The interface 1000 can assist the administrator or staff of the IT service end user 102 to manage individual services for Joni Sherman.

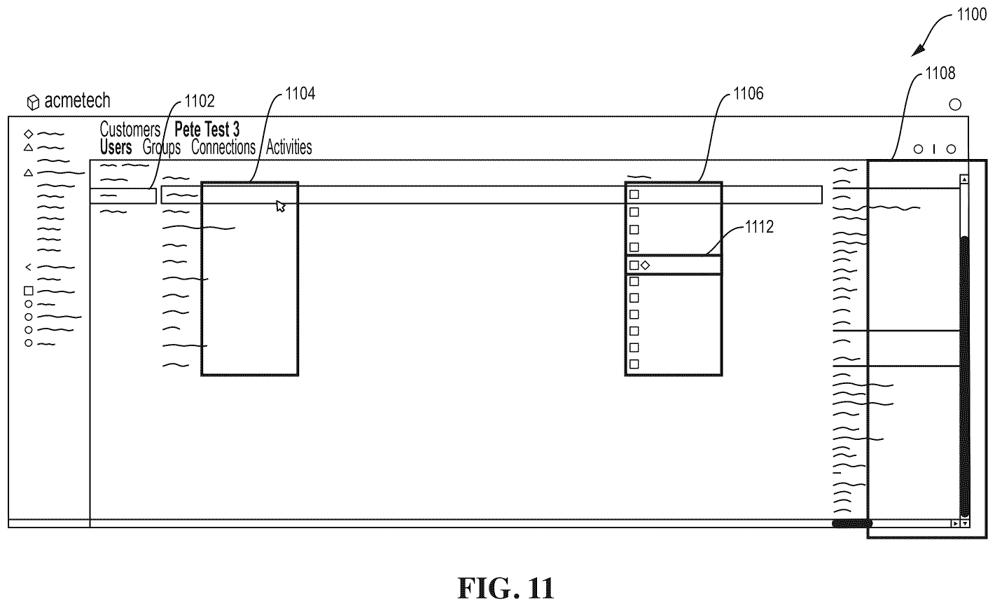

FIG. 11 shows another example interface 1100 for displaying a composite view of entities for a given customer in accordance with the present disclosure. In this example, entity type “groups” 1102 is selected for user Joni Sherman in interface 1100. Thus, block 1104 interface shows groups the user Joni Sherman belongs to. As noted previously, an asset may be labeled by asset type of “user” or “group.” For example, as shown in FIG. 3, asset #1-3 may be labeled by asset type of “user”, and asset #2-2 may be labeled by asset type of “group.” In some embodiments, asset #1-3 and asset #2-2 may be linked together. Block 1106 shows services individual groups are authorized to use. Block 1108 shows the properties of Webex service for Joni Sherman. Interface 1100 is developed to assist administrator or staff of the IT service end user 102 to navigate to manage groups for a given user easily and intuitively. Interface 1100 can be implemented because of the entity linking through semantic modeling-groups in different services are linked. In this example, groups “legal team” exit in MS 365 and Webex for customer acmetech, and thus they are shown next to each other in block 1112.

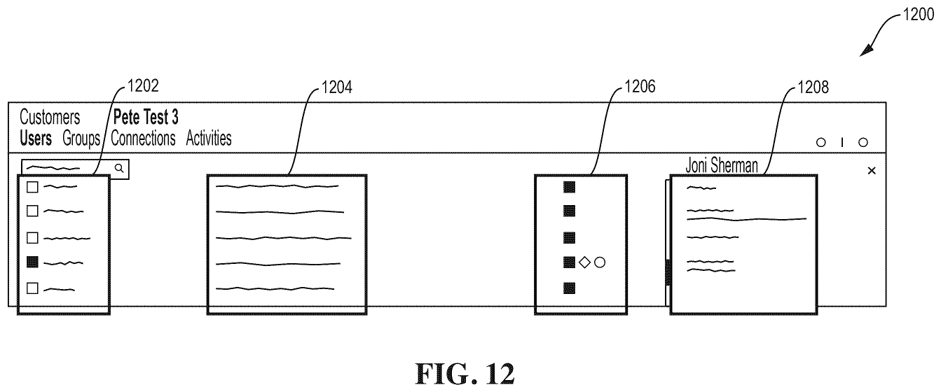

FIG. 12 shows an example interface 1200 for displaying common information for an entity across services in accordance with the present disclosure. As mentioned above, certain information about an entity may be common to all services the entity is associated with or authorized to use. Interface 1200 is developed to show such common information about an entity—user Joni Sherman in this example. As shown in FIG. 12, because Joni Sherman is selected in block 1202, block 1208 shows common information about Joni Sherman to services he is associated with (e.g., those shown in block 1206). In implementation, the common information shown in block 1208 may be obtained from the model user information—generic vocabularies as described above. Because the common information, such as the Email Address of the users shown in block 1204, is already stored according to the generic vocabularies of the model user information, common information shown in block 1208 can be quickly obtained and shown when Joni Sherman is selected in interface 1200. Interface 1200 can assist the administrator or staff of the IT service end user 102 to manage (e.g., making edits to) the common information about an entity and propagate the changes to all services Joni Sherman is associated with or authorized to use.

### IV. Asset Retrieving

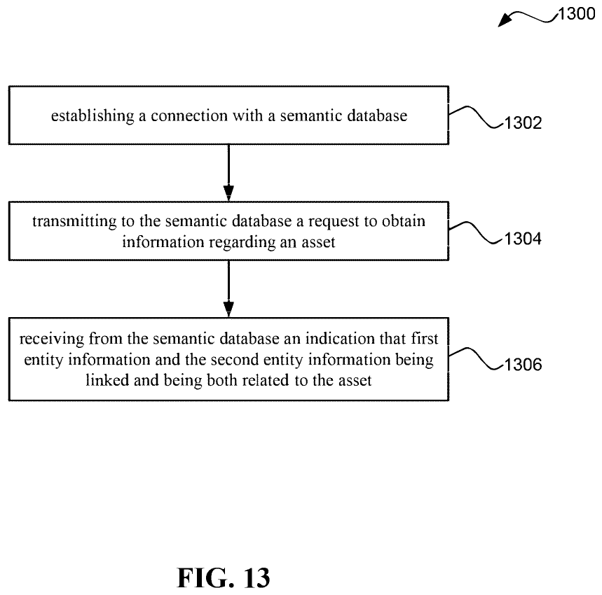

FIG. 13 illustrates an exemplary method 1300 for managing different assets of a graph database in accordance with the disclosure. Specifically, method 1300 may determine whether two assets should be linked. The operations of method 1300 presented below are intended to be illustrative. In some embodiments, method 1300 may be accomplished with one or more additional operations not described and/or without one or more of the operations discussed. Additionally, the order in which the operations of method 1300 are illustrated in FIG. 13 and described below is not intended to be limiting.

In some embodiments, method 1300 may be implemented in the management system 100 and/or one or more systems 104a-104n shown in FIG. 1, which may each include one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1300 in response to instructions stored electronically on an electronic storage medium. The one or more processing devices may include one or more devices configured through hardware, firmware, and/or software to be designed for execution of one or more of the operations of method 1300.

At block 1302, one or more requests may be generated and transmitted to manage system 100. These requests are configured to establish a connection with a semantic database. In some embodiments, the semantic database may include graph database 300. In some embodiments, the semantic database is configured to store information for different services, such as service #1 (e.g., Microsoft Office 365), service #2 (e.g., Dropbox), and/or service #3 (e.g., Webex) shown in FIG. 2. As one example, the information may include information regarding service #1 and service #2. In some embodiments, the information regarding service #1 may include user account information of service #1, and the information regarding service #2 may include user account information of service #2. In some embodiments, user account information of service #1 may be stored in graph database 300 as a node, such as asset #1-3, while user account information of service #2 may be stored in graph database 300 as a node, such as asset #2-3. In some embodiments, each of asset #1-3 and asset #2-3 may include entity information called properties, as described referring to FIG. 3. In some embodiments, some or all of the properties of asset #1-3 and asset #2-3 may be marked by a set of generic vocabularies as described above referring to FIG. 3.

At block 1304, one or more request may be generated and transmitted to the semantic database (e.g., graph database 300) to obtain information regarding an asset. For example, a request can be generated by IT service end user 102 through an interface 112 to obtain user information of a user named Joni Sherman. In some embodiments, the semantic meaning of the query information contained in the request may be interpreted as the value of the property marked up by a generic vocabulary. For example, the system may interpret the request for returning user account information from asset #1-3 and asset #2-3 with a given name of Joni and family name of Sherman.

At block 1306, entity information regarding an asset may be received from the semantic database (e.g., graph database 300). In some embodiments, a subset of properties of an asset or all of the properties of an asset may be returned. In some embodiments, a set of one or more common information items regarding the asset may be received. For example, the set of one or more common information items exist in the properties of asset #1-3 and exist in the properties of asset #2-3. In some embodiments, the set of properties of asset #1-3 and asset #2-3 marked by the generic vocabularies can be received. For example, the set of properties of asset #1-3 and asset #2-3 marked by GivenName, FamilyName, EmailAddress, and CellPhone from the generic vocabularies can be received. Thus the user information of given name, family name, email address, and cell phone about Joni Sherman can be retrieved. In some embodiments, the received information may include an indication that asset #1-3 and asset #2-3 being linked and being both related to the same user. For example, both the logos of service #1 (e.g., Microsoft Office 365) and service #2 (e.g., Dropbox) can be associated with the same user Joni Sherman.

In some embodiments, retrieving entity information regarding an asset may be implemented according to asset type. In some embodiments, after method 1300 retrieve from graph database 30 the data of an asset, it must determine whether the asset has a specific asset type. For example, in the scenario of retrieving user account information and a set of data information from an asset is received. It must determine whether the asset received has an asset type of “user.” If the asset type is affirmatively determined, method 1300 may include retrieving a set of one or more common information tokens for the asset type, and then parsing the asset data according to the set of one or more common information tokens; and generating a set of one or more information items based on a result of the parsing.

In some embodiments, one or more display request may be generated for displaying the asset in association with the services, such as service #1 and/or service #2. In response to the display request, some or all properties of asset #1-3 and/or asset #2-3 may be displayed, for example, on interface 112 of management system 100.

### V. Asset Linking

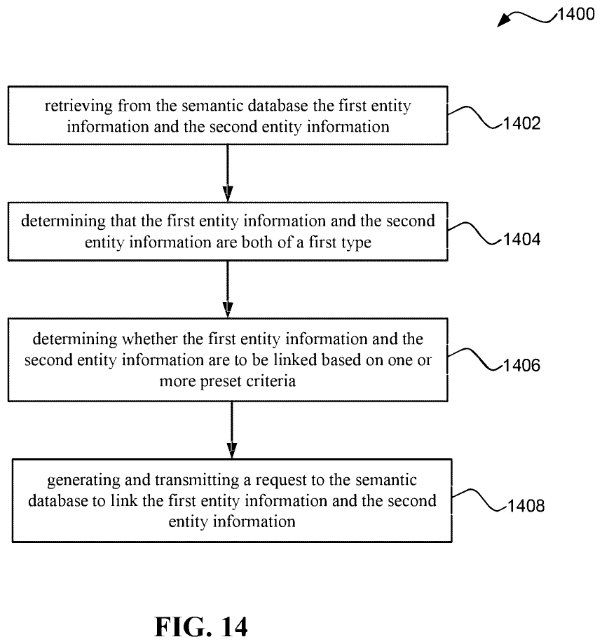

FIG. 14 illustrates an example method 1400 for linking assets in accordance with the present disclosure. For example, method 1400 may be performed before method 1300. The operations of method 1400 presented below are intended to be illustrative. In some embodiments, method 1400 may be accomplished with one or more additional operations not described and/or without one or more of the operations discussed. Additionally, the order in which the operations of method 1400 are illustrated in FIG. 14 and described below is not intended to be limiting.

In some embodiments, method 1400 may be implemented in the management system 100 and/or one or more systems 104a-104n shown in FIG. 1, which may each include one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1400 in response to instructions stored electronically on an electronic storage medium. The one or more processing devices may include one or more devices configured through hardware, firmware, and/or software to be designed for execution of one or more of the operations of method 1400.

At block 1402, one or more requests for retrieving information from a semantic database (e.g., graph database 300) may be generated and sent to the semantic database. In some embodiments, the semantic meaning of the query information contained in the request may be interpreted as value of the property marked by a generic vocabulary. For example, the system may interpret the request for returning email address information from graph database 300. For example, asset #1-3 and asset #1-2 both include the email address information as requested, and asset #2-3 also includes the email address information as requested. As described above, each asset is assigned with an asset type. For example, asset #1-3 is assigned an asset type of “user,” asset #1-2 is assigned an asset type of “license,” and asset #2-3 is assigned an asset type of “user.” Then some or all properties of asset #1-3, asset 1-2, and asset #2-3 may be identified as response results.

At block 1404, method 1400 may determine that the assets identified in the response result are of the same asset type. As one example, method 1400 may determine that asset #1-3 and asset 2-3 have the same asset type labeled as “user.”

At block 1406, method 1400 may determine whether the assets with the same asset type should be linked based on one or more preset criteria. In some embodiments, the properties of two assets marked by the same generic vocabulary may be compared to determine if the two assets should be linked by an equivalent edge. For example, the value of the property “UserPrincipleName” of asset #1-3 marked by “EmailAddress” in generic vocabularies can be compared with the value of the property “email” of asset #2-3 marked by “EmailAddress” in generic vocabularies to determine if asset #1-3 and asset #2-3 share the same email address, which is an indication that asset #1-3 and asset #2-3 represent the same user subscribed to service #1 (e.g., Microsoft Office 365) and service #2 (e.g., Dropbox). If asset #1-3 and asset #2-3 share the same email address, asset #1-3 and asset #2-3 can be linked by an equivalent edge, and both of asset #1-3 and asset #2-3 can be included in the transitive cluster.

It should be noted the above criteria is presented as an example. Any criteria may be contemplated and should be included in the protection scope of the present disclosure if they can determine two assets are equivalent to each other. In some embodiments, a composite comparison strategy may be adopted. Different properties of an asset may be considered in this composite comparison strategy. For example, some or all of the properties of two assets marked by “GivenName,” “FamilyName,” “EmailAddress,” and “CellPhone” in generic vocabularies may be compared to determine if two assets should be linked by an equivalent edge. For example, if at least two properties of two assets marked by generic vocabularies are identical to each other, then it can be determined that the two assets are to be linked. For example, asset #1-3 and asset #2-3 both have a display name of Joni Sherman and the same email address. Method 1400 may determine asset #1-3 and asset #2-3 should be linked if they both include the same cell phone numbers.

At block 1408, in response to the determination that the assets in the response results are to be linked, one or more requests may be generated and transmitted to the semantic database (e.g., graph database 300) to link the assets. For example, asset #1-3 and asset #2-3 may be linked by an equivalent edge. In some embodiments, asset #1-3 and asset #2-3 may be further included in a transitive cluster labeled as “common user.”

In some embodiments, additional assets may be linked to those assets already linked together. For example, the response results at block 1402 include asset #1-3, asset #2-3, and asset #3-3. Then at block 1404, method 1400 may determine that the assets identified in the response result are of the same asset type. For example, asset #3-3 is also assigned an asset type labeled as “user.” At block 1406, method 1400 may determine whether the assets with the same asset type should be linked based on one or more preset criteria. In some embodiments, the preset criteria may include at least two of the following: asset #1-3 and asset #2-3 are already linked by an equivalent edge, asset #1-3 and asset #3-3 are already linked by an equivalent edge, and asset #2-3 and asset #3-3 are already linked by an equivalent edge. In some embodiments, asset #1-3, asset 2-3, and asset #3-3 may be included in the transitive cluster labeled as “common user.”

### VI. Asset Unlinking

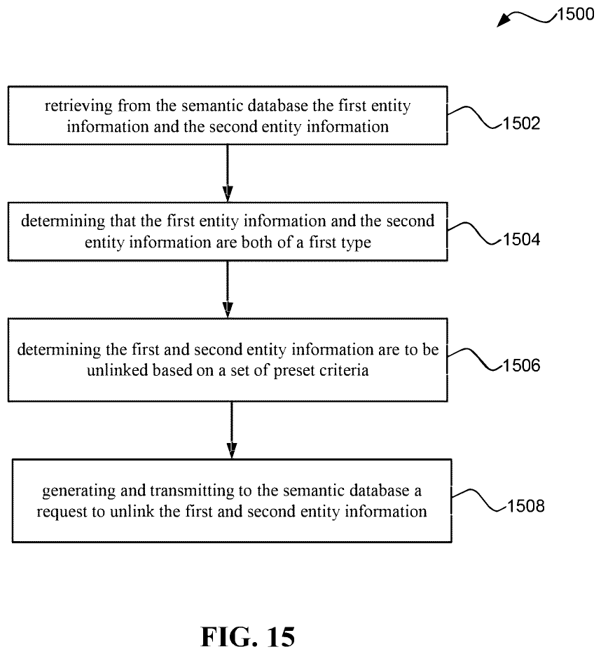

FIG. 15 illustrates an example method 1500 for unlinking assets in accordance with the present disclosure. For example, method 1500 may be performed after method 1400. The operations of method 1500 presented below are intended to be illustrative. In some embodiments, method 1500 may be accomplished with one or more additional operations not described and/or without one or more of the operations discussed. Additionally, the order in which the operations of method 1500 are illustrated in FIG. 15 and described below is not intended to be limiting.

In some embodiments, method 1500 may be implemented in the management system 100 and/or one or more systems 104a-104n shown in FIG. 1, which may each include one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1500 in response to instructions stored electronically on an electronic storage medium. The one or more processing devices may include one or more devices configured through hardware, firmware, and/or software to be designed for execution of one or more of the operations of method 1500.

At block 1502, one or more request for retrieving information from a semantic database (e.g., graph database 300) may be generated and sent to the semantic database. In some embodiments, the semantic meaning of the query information contained in the request may be interpreted as value of the property marked up by a generic vocabulary. For example, the system may interpret the request for returning email address information from graph database 300. For example, asset #1-3 and asset #1-2 both include the email address information as requested, and asset #2-3 also includes the email address information as requested. As described above, each asset is assigned with an asset type. For example, asset #1-3 is assigned an asset type of “user,” asset #1-2 is assigned an asset type of “license,” and asset #2-3 is assigned an asset type of “user.” Then some or all properties of asset #1-3, asset 1-2, and asset #2-3 may be identified as response results.

At block 1504, method 1500 may determine that the assets identified in the response result are of the same asset type. As one example, method 1500 may determine that asset #1-3 and asset #2-3 have the same asset type labeled as “user.” In some embodiment, method 1500 may further determine that the assets identified in the response results are linked together. For example, method 1500 may determine asset #1-3 and asset #2-3 are already linked together by a equivalent edge. In some embodiments, method 1500 may determine asset #1-3 and asset #2-3 are included in the transitive cluster labeled as “common user.”

At block 1506, method 1500 may determine the assets identified in the response results are to be unlinked based on a set of preset criteria. In some embodiments, the preset criteria may include: one asset identified in the response results must be removed from the semantic database. For example, asset #2-3 must be removed from graph database 300 for a certain reason, such as, the user represented by asset #2-3 stops using service #2 (e.g., Dropbox). In some embodiments, the preset criteria may include: the assets identified in the response results must be unlinked for certain reasons, such as asset #1-3 and asset #2-3 were linked by mistake. It should be noted the criteria presented above intends for illustration purposes. Any criteria for unlinking assets may be contemplated.

At block 1508, one or more requests may be generated and transmitted to the semantic database to unlink the assets identified in the response results. For example, asset #1-3 and asset #2-3 may be unlinked in response to the request.

In some embodiments, the response results of block 1502 and block 1504 may return more than two assets linked together. For example, asset #1-3, asset #2-3, and asset #3-3 are linked together. In some embodiments, all of asset #1-3, asset #2-3, and asset #3-3 are included in the transitive cluster labeled as “common user.” At block 1506, it is determined that asset #2-3 should be unlinked from asset #1-3 and asset #3-3. Then at block 1508, asset #2-3 may be unlinked from asset #1-3 and asset #3-3 in response to the request, while assets #1-3 and asset #3-3 may remain linked. In some embodiments, in response to the request, asset #2-3 may be removed from the transitive cluster labeled as “common user,” and asset #1-3 and asset #3-3 still remain in the transitive cluster.

### VII. Computer System

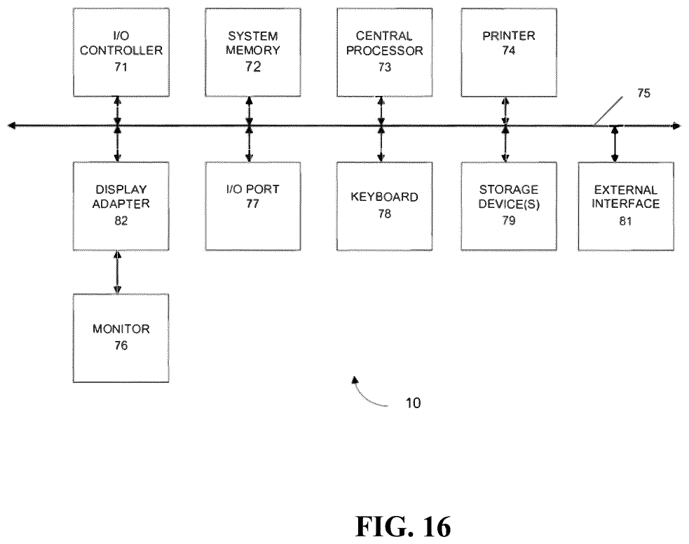

Any of the computer systems mentioned herein may utilize any suitable number of subsystems. Examples of such subsystems are shown in FIG. 16 in computer system 10, which can be configured to implement various features and/or functions described herein. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 16 are interconnected via a system bus 75. Additional subsystems such as a printer 74, keyboard 78, storage device(s) 79, monitor 76, which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWireR). For example, I/O port 77 or external interface 81 (e.g. Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of instructions from system memory 72 or the storage device(s) 79 (e.g., a fixed disk, such as a hard drive or optical disk), as well as the exchange of information between subsystems. The system memory 72 and/or the storage device(s) 79 may embody a computer readable medium. Any of the data mentioned herein can be output from one component to another component and can be output to the user.

A computer system can include a plurality of the same components or subsystems, e.g., connected together by external interface 81 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing the respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications, and descriptions mentioned herein are incorporated by reference in their entirety for all purposes. None is admitted to be prior art.

1-18. (canceled)

19. An information management method for service administration, the method being implemented by one or more computer servers and comprising:
establishing a connection with a graph database, wherein the graph database is configured to store information for different services provided to a same entity using a graph model, the information comprising first entity information regarding a first service provided by a first service provider and second entity information regarding a second service provided by a second service provider, wherein the information regarding the first service includes a first entity information and the information regarding the second service are provided to a same includes a second entity information;
transmitting to the graph database a request to obtain information regarding an asset within associated with the same entity;
receiving from the graph database an indication that the asset is linked to the first entity information and the second entity information are linked as related to the asset;
establishing an edge in the graph database between the first and second entity information;
obtaining the first entity information from the first service and the second entity information from the second service, the first entity information including a first plurality of properties and the second entity information including a second plurality of properties;
storing the first entity information and the second entity information in the graph database; and
annotating each of the first entity information plurality of properties and each of the second entity information plurality of properties with one of a set of generic vocabularies representing property types within the first and second entity information, wherein a first property of the first entity information plurality of properties is annotated with a first generic vocabulary indicating the first property is of a first property type, and a second property of the second entity information plurality of properties is annotated with the first generic vocabulary indicating that the second property is of the first property type.

20. The information management method of claim 19 further comprising: generating a display request for displaying the asset in association with the first service and second service.

21. The information management method of claim 19, wherein the asset comprises a user, a user group, a license, a file, a mailbox, a hardware, a computing device and/or an organization.

22. The information management method of claim 19, further comprising:
retrieving from the graph database the first entity information and the second entity information;
determining that the first entity information and the second entity information are both of a first type;
determining whether the first entity information and the second entity information are to be linked based on one or more preset criteria; and
in response to the determination that the first entity information and second entity information are to be linked, generating and transmitting a request to the graph database to link the first entity information and the second entity information.

23. The information management method of claim 19, further comprising: retrieving from the graph database the first entity information and the second entity information; and
determining the first and second entity information are to be unlinked based on a set of preset criteria; and
generating and transmitting to the graph database a request to unlink the first and second entity information.

24. The information management method of claim 19, wherein annotating the first entity information and the second entity information with the set of generic vocabularies comprises:
retrieving from the graph database the first entity information;
determining the first entity information is of a first type;
retrieving one or more generic vocabularies from the set of generic vocabularies based on
the first type;
annotating the first entity information according to the one or more generic vocabularies.

25. The information management method of claim 19, wherein the method further comprises:
creating a common entity including a first common entity, wherein the first common entity includes the first generic vocabulary.

26. A computer system configured to managing information for service administration, the computer system comprising one or more processor configured to execute machine-readable instructions to cause the computer system to perform:
establishing a connection with a graph database, wherein the graph database is configured to store information for different services provided to a same entity using a graph model, the information comprising first entity information regarding a first service provided by a first service provider and second entity information regarding a second service provided by a second service provider, wherein the information regarding the first service includes a first entity information and the information regarding the second service are provided to a same includes a second entity information;
transmitting to the graph database a request to obtain information regarding an asset within associated with the same entity;
receiving from the graph database an indication that the asset is linked to the first entity information and the second entity information are linked as related to the asset;
establishing an edge in the graph database between the first and second entity information;
obtaining the first entity information from the first service and the second entity information from the second service, the first entity information including a first plurality of properties and the second entity information including a second plurality of properties;
storing the first entity information and the second entity information in the graph database; and
annotating each of the first plurality of properties entity information and each of the second entity information plurality of properties with one of a set of generic vocabularies representing property types within the first and second entity information, wherein a first property of the first entity information plurality of properties is annotated with a first generic vocabulary indicating the first property is of a first property type₂ and a second property of the second plurality of properties entity information is annotated with the first generic vocabulary indicating that the second property is of the first property type.

27. The computer system of claim 26 is further caused to perform:
generating a display request for displaying the asset in association with the first service and second service.

28. The computer system of claim 26, wherein the asset comprises a user, a user group, a license, a file, a mailbox, a hardware, a computing device and/or an organization.

29. The computer system of claim 26 is further caused to perform: retrieving from the graph database the first entity information and the second entity information;
determining that the first entity information and the second entity information are both of a first type;
determining whether the first entity information and the second entity information are to be linked based on one or more preset criteria; and
in response to the determination that the first entity information and second entity information are to be linked, generate and transmit a request to the graph database to link the first entity information and the second entity information.

30. The computer system of claim 26 is further caused to perform: retrieving from the graph database the first entity information and the second entity information; and
determining the first and second entity information are to be unlinked based on a set of preset criteria; and
generating and transmitting to the graph database a request to unlink the first and second entity information.

31. The computer system of claim 26, wherein annotating the first entity information and the second entity information with the set of generic vocabularies comprises:
retrieving from the graph database the first entity information;
determining the first entity information is of a first type;
retrieving one or more generic vocabularies from the set of generic vocabularies based on the first type;
annotating the first entity information according to the one or more generic vocabularies.

32. The computer system of claim 26 is further caused to perform: creating a common entity including a first common entity, wherein the first common entity includes the first generic vocabulary.
